(19) United States
(12) Patent Application Publication
(10) Pub. No.: US 2021/0209562 A1
(43) Pub. Date: Jul. 8, 2021

(54) Analytics and Device Management Platform for Human Interaction

(71) Applicant: Plantronics, Inc., Santa Cruz, CA (US)

(72) Inventors: Daniel Paul Lange, Thornton, CO (US); Jeffrey Charles Adams, Lafayette, CO (US); Eric Jay Nylander, Westminster, CO (US)

(73) Assignee: Plantronics, Inc., Santa Cruz, CA (US)

(21) Appl. No.: 17/139,833

(22) Filed: Dec. 31, 2020

Related U.S. Application Data
(60) Provisional application No. 62/956,932, filed on Jan. 3, 2020.

(51) Int. Cl. G06Q 10/10; G06Q 10/06

(52) U.S. Cl. CPC G06Q 10/1095; G06Q 10/06311; G06Q 10/06312

(57) ABSTRACT

An analytics and device management platform includes a computer processor and instructions executing on the computer processor and causing the platform to obtain metrics from at least one endpoint. Each of the metrics is a quantification of a phenomenon detected in at least one of audio and video data obtained from an endpoint facilitating communication between meeting attendees. The instructions further cause the platform to generate indicators based on the metrics. Each of the indicators is a numeric descriptor derived from at least one of the metrics, and each of the indicators is of potential relevance to a user of the platform to inform a decision by the user. The instructions also cause the platform to determine at least one insight based on the indicators. The at least one insight is an indicator determined to be of relevance to the user to inform the decision.

### CROSS-REFERENCE TO RELATED APPLICATIONS

This application claims the benefit of priority under 35 U S.C. § 119(e) to U.S. Provisional Patent Application Ser. No. 62/956,932, filed on Jan. 3, 2020, which is hereby incorporated by reference herein in its entirety.

### BACKGROUND

Remote human interaction, such as in professional and educational environments, frequently relies on various physical resources. For example, the physical resources may include conference rooms, video and audio-conferencing equipment, laptops, whiteboards, smartboards, etc. The various physical conference resources may span a large infrastructure that is connected via a network. Organizations providing such resources may benefit from obtaining insight into whether and how the various physical resources are utilized.

### SUMMARY

In general, in one aspect, one or more embodiments relate to an analytics and device management platform comprising: a computer processor; and instructions executing on the computer processor causing the analytics and device management platform to: obtain metrics from at least one endpoint, wherein each of the metrics is a quantification of a phenomenon detected in at least one of audio and video data obtained from an endpoint configured to facilitate communication between meeting attendees; generate indicators based on the metrics, wherein each of the indicators is a numeric descriptor derived from at least one of the metrics, and wherein each of the indicators is of potential relevance to a user of the analytics and device management platform to inform a decision by the user; determine at least one insight based on the indicators, wherein the at least one insight is an indicator determined to be of relevance to the user to inform the decision; and provide the at least one insight to a user interface for visualization.

In general, in one aspect, one or more embodiments relate to a method for operating an analytics and device management platform, the method comprising: obtaining metrics from at least one endpoint, wherein each of the metrics is a quantification of a phenomenon detected in at least one of audio and video data obtained from an endpoint configured to facilitate communication between meeting attendees; generating indicators based on the metrics, wherein each of the indicators is a numeric descriptor derived from at least one of the metrics, and wherein each of the indicators is of potential relevance to a user of the analytics and device management platform to inform a decision by the user; determining at least one insight based on the indicators, wherein the at least one insight is an indicator determined to be of relevance to the user to inform the decision; and providing the at least one insight to a user interface for visualization.

In general, in one aspect, one or more embodiments relate to a non-transitory computer readable medium comprising computer readable program code causing an analytics and device management platform to: obtain metrics from at least one endpoint, wherein each of the metrics is a quantification of a phenomenon detected in at least one of audio and video data obtained from an endpoint configured to facilitate communication between meeting attendees; generate indicators based on the metrics, wherein each of the indicators is a numeric descriptor derived from at least one of the metrics, and wherein each of the indicators is of potential relevance to a user of the analytics and device management platform to inform a decision by the user; determine at least one insight based on the indicators; wherein the at least one insight is an indicator determined to be of relevance to the user to inform the decision; and provide the at least one insight to a user interface for visualization.

Other aspects of the embodiments will be apparent from the following description and the appended claims.

### BRIEF DESCRIPTION OF DRAWINGS

FIG. 1 shows an analytics and device management platform that supports human interaction, in accordance with one or more embodiments of the disclosure.

FIG. 2 shows an endpoint in accordance with one or more embodiments of the disclosure.

FIG. 3A shows an analytics service in accordance with one or more embodiments of the disclosure.

FIG. 3B shows an example implementation of an analytics service in accordance with one or more embodiments of the disclosure.

FIG. 4 shows a sitemap of an analytics user interface in accordance with one or more embodiments of the disclosure.

FIG. 5 shows a flowchart describing a method for a processing performed by an endpoint, in accordance with one or more embodiments of the disclosure.

FIG. 6 shows a flowchart describing a method for a processing performed by an analytics service, in accordance with one or more embodiments of the disclosure.

FIGS. 7A, 7B, 7C, and 7D show examples of analytics user interfaces, in accordance with one or more embodiments of the disclosure.

FIG. 8 shows notability markers, in accordance with one or more embodiments of the disclosure.

FIGS. 9A and 9B show computing systems in accordance with one or more embodiments of the disclosure.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.)

may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, although the description includes a discussion of various embodiments of the disclosure, the various disclosed embodiments may be combined in virtually any manner. All combinations are contemplated herein.

In general, embodiments of the disclosure perform network monitoring and analytics to determine usage and operability of physical resources spanning large infrastructures. The resources are used for human interaction with each other. For example, the resources may be used for conferencing and/or other meetings. One or more embodiments are directed to configuring a computing system to use parameters from devices and hardware to extract aspects of scenarios involving human interaction. Embodiments of the disclosure involve the use of technology facilitating human interaction, such as audio and/or video conferencing solutions.

A conferencing solution may include one or more endpoints allowing one or more meeting attendees to communicate with remote meeting attendees. An endpoint may be equipped with one or more cameras, one or more microphones, and/or other components. An endpoint may alternatively have no camera. While the endpoint is primarily designed to enable communication between meeting attendees, the endpoint may additionally be used to monitor various parameters associated with the use of the endpoint by the conference attendees, the environment in which the endpoint is installed, the functioning of the endpoint itself, etc.

The computing system executes computer models on the various parameters to extract information. After processing the parameters, meaningful information may be presented to an administrator overseeing the endpoint or a set including multiple endpoints installed in different conference rooms across a building, across a campus, or across an entire organization. For example, an administrator may learn about conference room utilization, endpoint usage, endpoint issues such as failures, connectivity issues, etc.

The computer models may both identify the use of the resources as well as define a focus of the information presented based on the particular user. Thus, the computer models automatically order the information according to relevancy for a particular user. Recommendations for an improved meeting attendee experience, a better conference room utilization, etc. may be made. The recommendations may be customized for the type of administrator receiving the recommendations. For example, a facilities administrator may receive information and/or recommendations associated with conference room utilization, whereas an information technology (IT) administrator may receive information and/or recommendations associated with the endpoint, such as available firmware upgrades. Examples of systems and methods implementing these and other features are subsequently described.

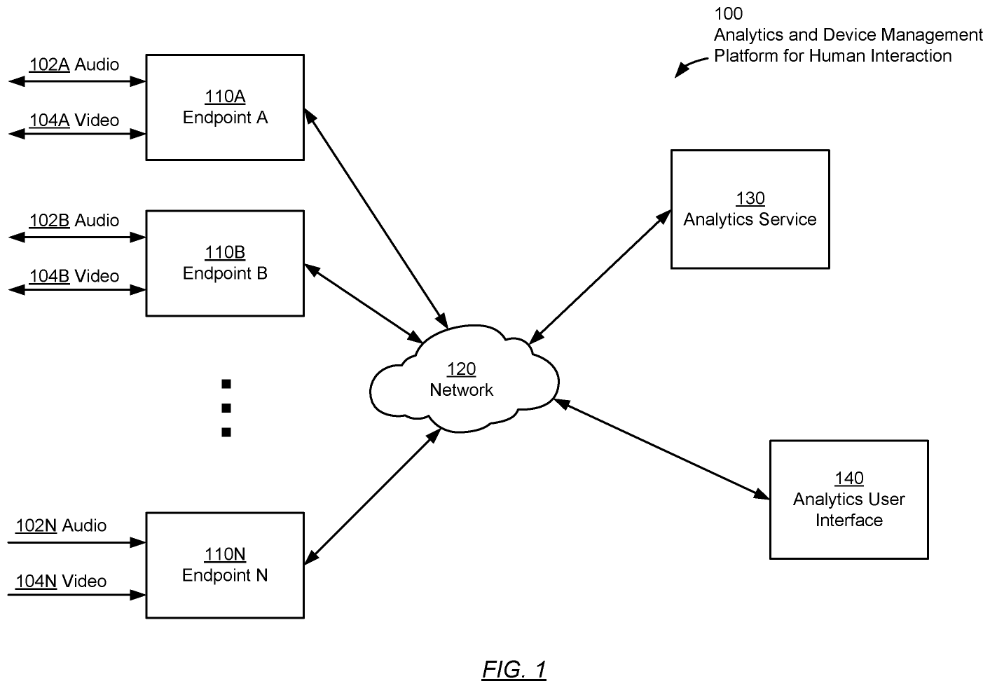

Turning to FIG. 1, an analytics and device management platform or system (100) for human interaction, in accordance with one or more embodiments of the disclosure, is shown. The system (100) may include one or more endpoints (110A-110N), an analytics service (130), and an analytics user interface (140). Each of these components is subsequently described.

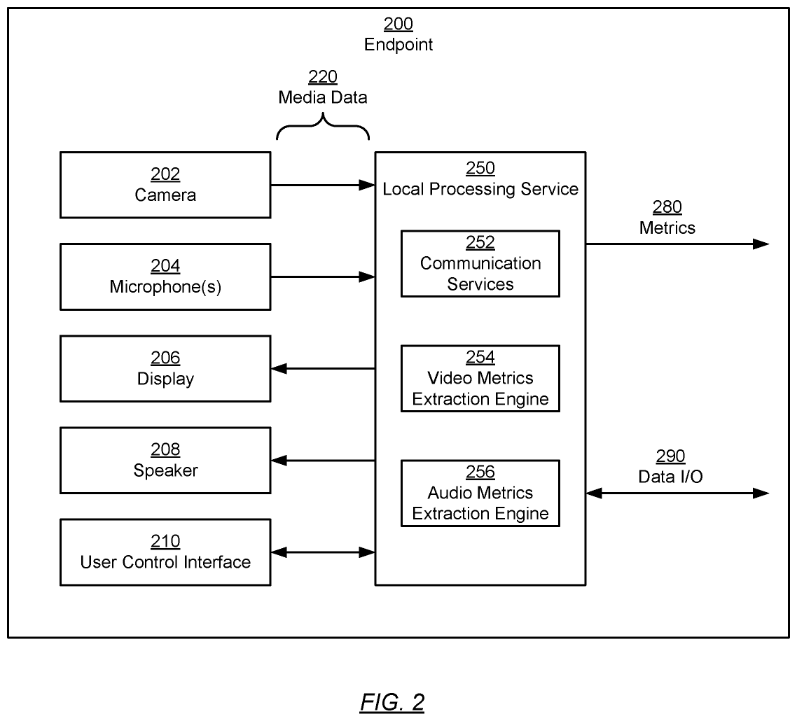

Each endpoint (110A-110N) may be a device installed, for example, in a meeting room to facilitate communication between meeting attendees, and in particular between remote meeting attendees. Example endpoints include audio and/or video-conferencing devices, including cameras, speakers, speaker phones, headsets, smartboards, telephones, computer systems that support the network connections, and other equipment. For example, endpoint A (110A) may enable meeting attendees to join a conference call with meeting attendees using endpoint B (110B). An endpoint may support audio (102A-102N) and/or video (104A-104N) communication between meeting attendees. In addition to enabling communication between meeting attendees, an endpoint may also gather various data obtained by analyzing the audio and/or video communications between meeting attendees and other data available at the endpoint. The gathered data may be forwarded to the analytics service (130) for further processing. A more detailed description of an endpoint is provided below with reference to FIG. 2.

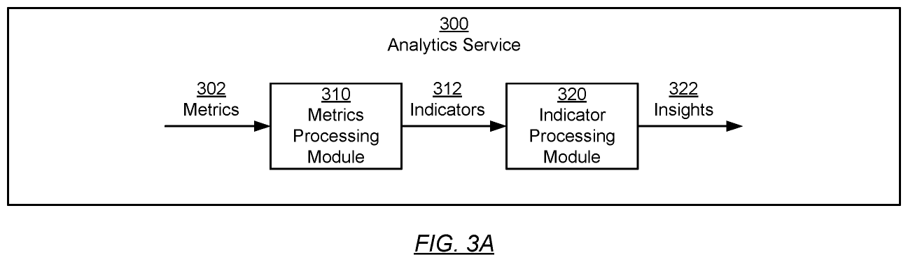

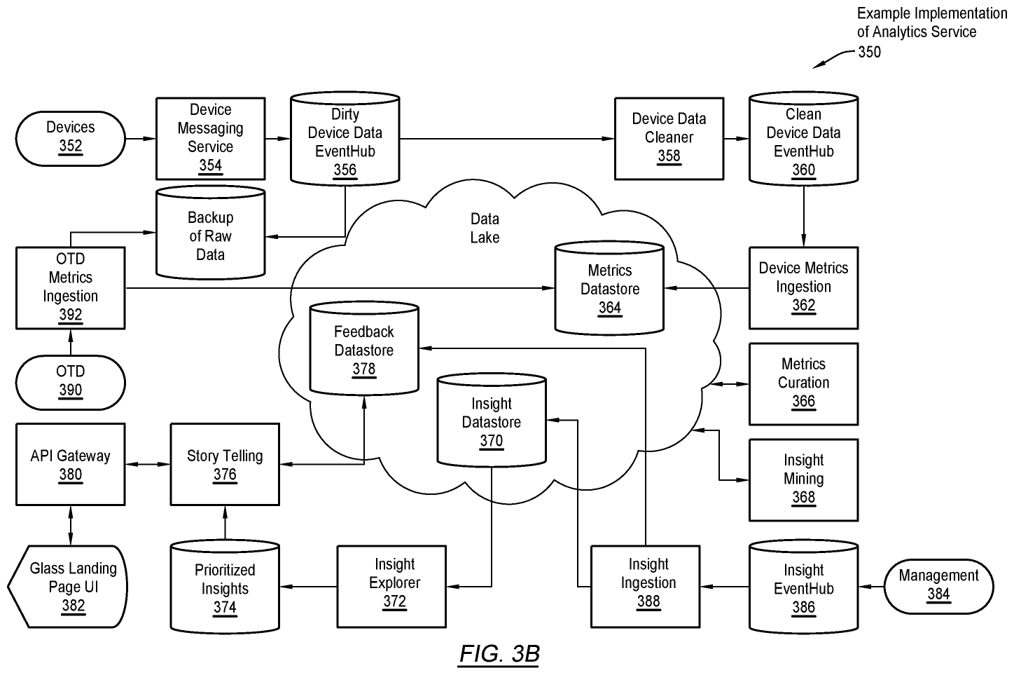

In one or more embodiments, the analytics service (130) processes the data provided by the endpoints (110A-110N) to obtain information to be visualized in the analytics user interface (140). The information may include, for example, insights and/or recommendations derived from the data. The processing of the data may be performed to various degrees as described in detail below with reference to FIGS. 3A and 3B. The analytics service (130) may be cloud-hosted.

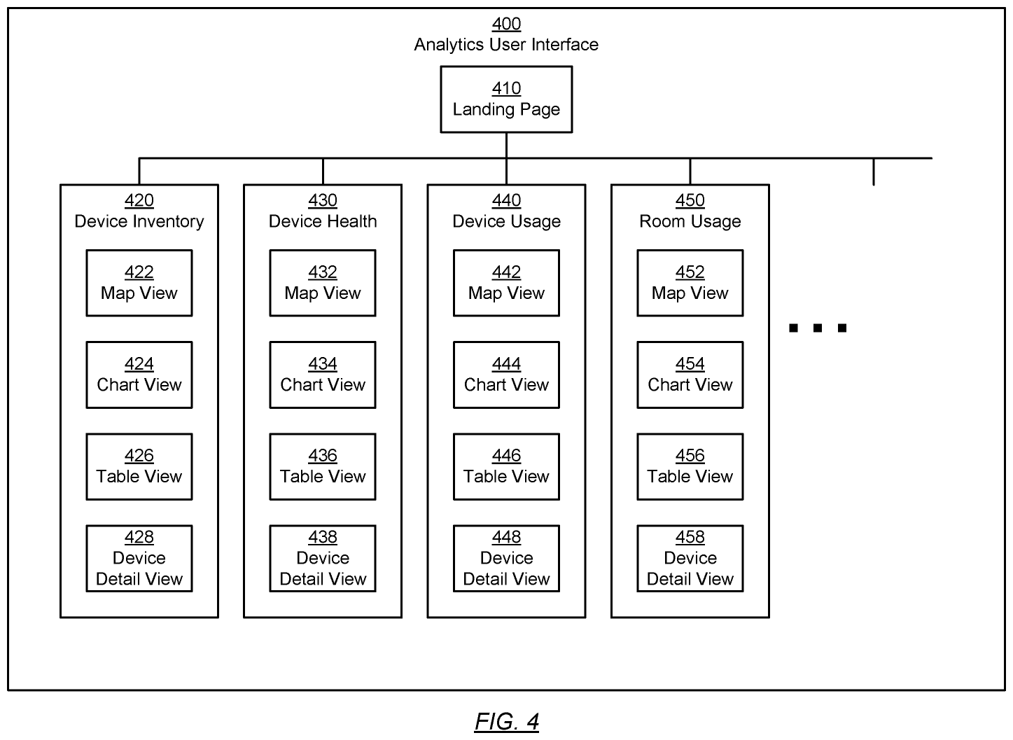

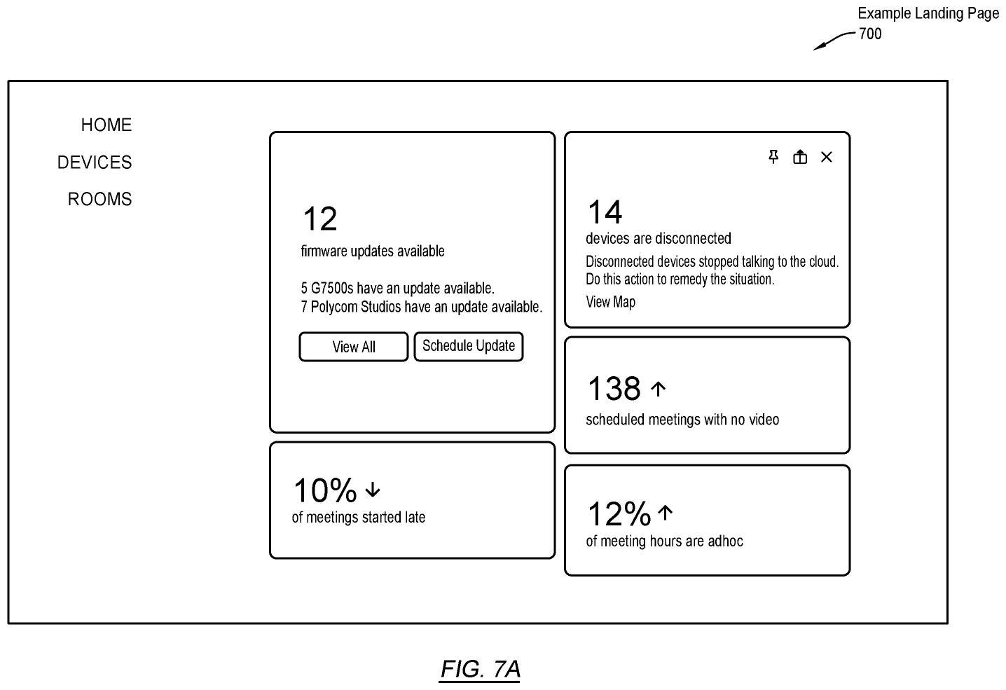

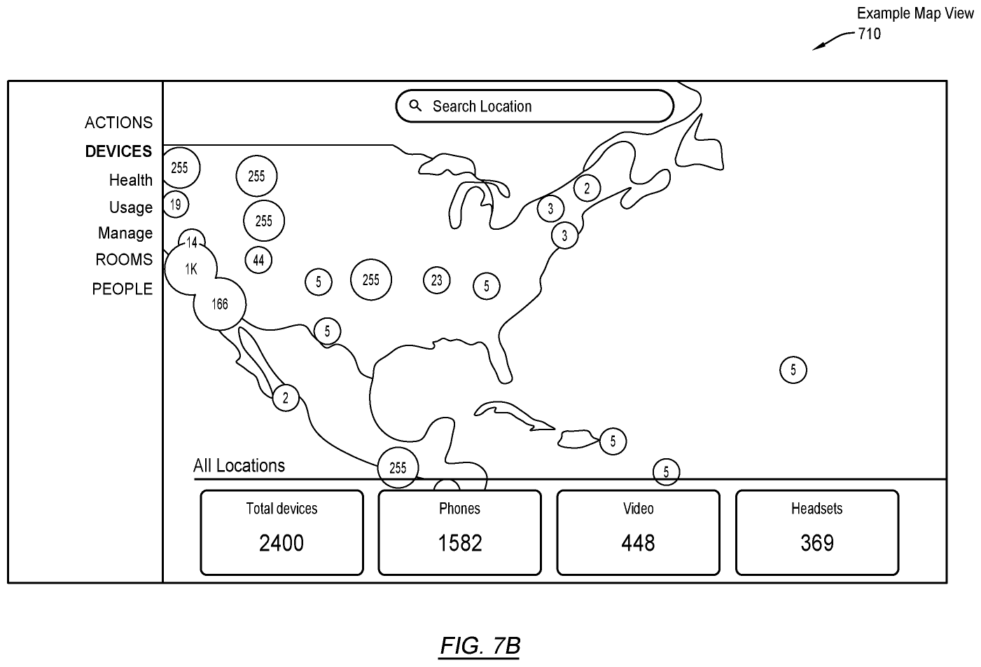

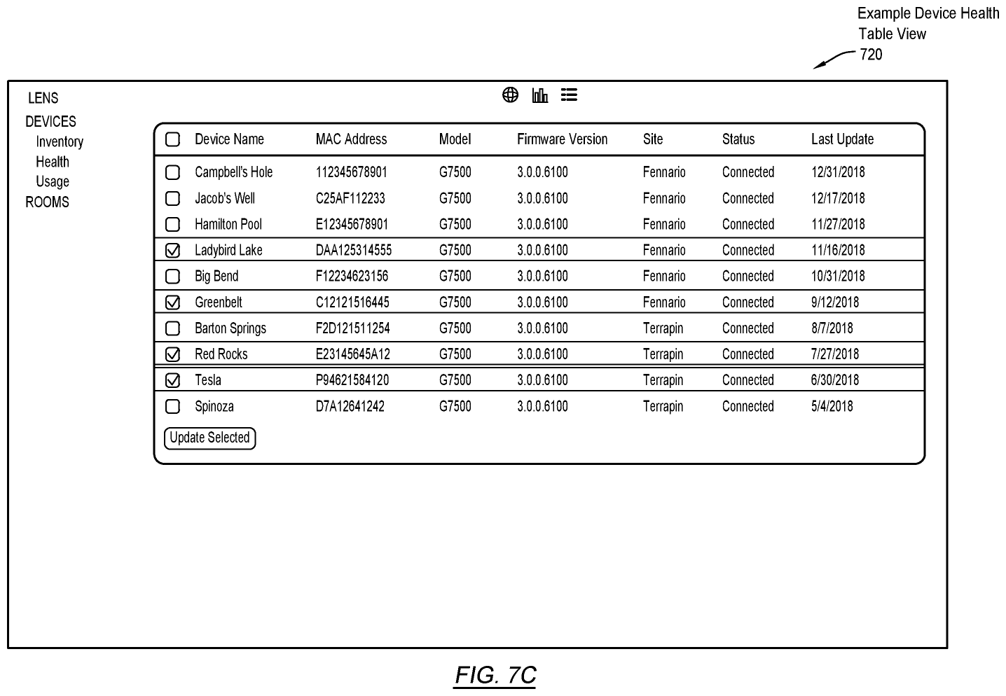

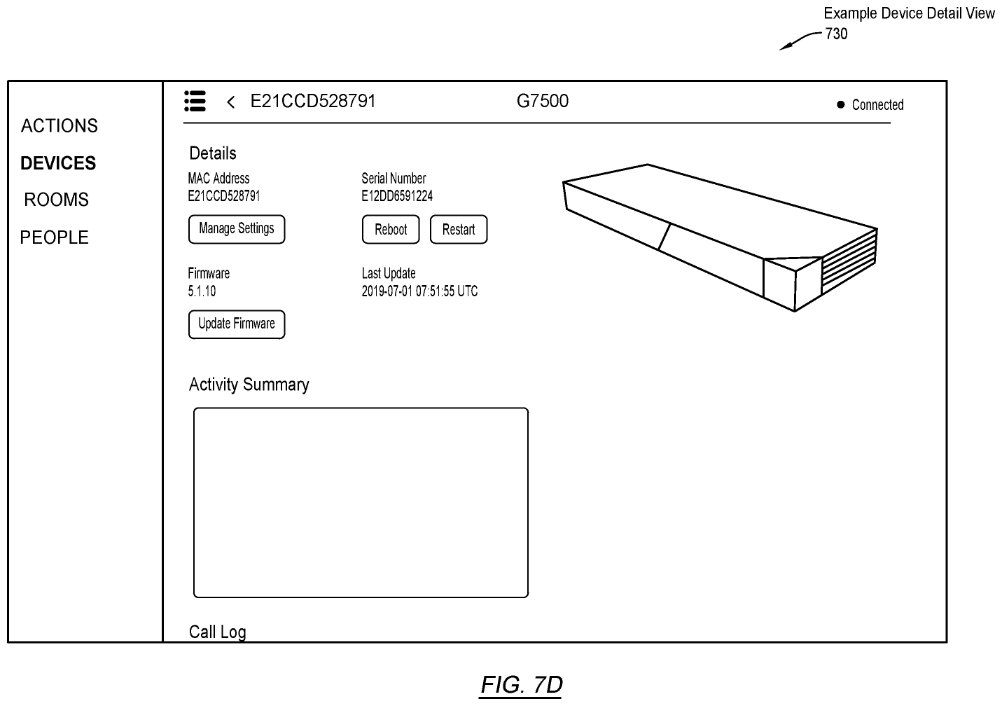

In one or more embodiments, the analytics user interface (140) generates a visualization of the data gathered from the endpoints (110A-110N) and processed by the analytics service (130). The type of data being visualized, and the degree of processing may depend on the type of user or administrator accessing the analytics user interface (140). Details of the analytics user interface (140) are provided below with reference to FIG. 4. The analytics user interface (140) may be provided on a local computing device, such as a desktop personal computer, a laptop, a tablet computer, a smartphone, etc. The analytics user interface (140) may be implemented as a standalone application, a browser-based app, a remotely accessible, cloud-hosted app, etc. Example output by the analytics user interface (140) is shown in FIGS. 7A, 7B, 7C, and 7D.

The endpoints (110A-110N), the analytics service (130), and the analytics user interface (140) may communicate using any combination of wired and/or wireless communication protocols via the network (120). The network (120) may include a wide area network (e.g., the Internet), and/or a local area network (e.g., an enterprise or home network). The communication between the components of the system (100) may include any combination of secured (e.g., encrypted) and non-secured (e.g., un-encrypted) communication. The manner in which the components of the system (100) communicate may vary based on the implementation.

While FIG. 1 shows a configuration of components, other configurations may be used without departing from the scope of the disclosure. For example, the system (100) may include additional hardware and or software components not shown in FIG. 1. In one embodiment, the system (100) includes extensions that interface with calendar and/or meeting scheduling software to enable communication of scheduled meeting data to the endpoints. Additional components not shown in FIG. 1 include, for example, call servers used for conducting conference calls. Also, while the configuration shown in FIG. 1 is primarily set up for conference calls (audio and/or video), various aspects of the configuration may also be used for purely local meetings.

FIG. 1 shows a few endpoints. All, a substantial part, or some of the endpoints may be in a building, a campus, a set of campuses, spanning a large global corporation. The system (100) may be designed to operate on a global level. The analytics service (130) and/or other components may be operated by a service provider. The service provider may provide the analytics service (130) to one or more tenants (e.g., an organization using endpoints). Each tenant may have one or more sites (e.g., a campus, a building, etc.). Multiple or many endpoints may be used by a tenant. For example, a tenant may operate multiple conference rooms equipped with endpoints. Because each of the endpoints may produce information, the system is capable of handling massive volumes of information, both gathered and/or determined from the various endpoints. Further, the system described herein may filter the output to the relevant information, whereby relevancy is automatically determined using a variety of dynamically weighted factors.

Turning to FIG. 2, an endpoint (200), in accordance with one or more embodiments, is shown. The endpoint may be a physical conferencing device located in a meeting room. As another example, the endpoint may be or may include a set of physical devices or software devices. In one or more embodiments, the primary purpose of the endpoint is to enable meeting attendees in the meeting room to conduct a meeting with other meeting attendees that are located elsewhere (e.g., another room in another building, city, state, or country). In one or more embodiments, the endpoint (200) further gathers data to be used for deriving insights and/or recommendations regarding various aspects of the endpoint, the environment surrounding the endpoint (e.g., a meeting room), and the usage of the endpoints and other resources in the vicinity, as discussed below.

The endpoint (200) may include one or more of the following: a camera (202), a microphone (204), a display (206), a speaker (208), and/or a user control interface (210). The endpoint (200) further includes a local processing service (250) that outputs metrics (280), and sends and receives data (290) (e.g., audio and video data of an ongoing meeting, configuration data, firmware updates, status information, etc.). Each of these components is subsequently described.

The camera (202) is configured to capture image/video frames of a meeting site such as a conference room. The camera may be equipped with a wide-angle lens to maximize coverage within the conference room. The camera may be high-resolution, e.g. 4 k, and may provide 2D or 3D images.

The microphone (204) is configured to capture audio signals at the meeting site. The microphone may be optimized for capturing speech. An array of microphones may be used to enable speaker localization.

The display (206) is configured to provide image/video output to the meeting attendees in the conference room to see remote meeting attendees, shared documents, etc. The display may include one or more wall mounted large display panels.

The speaker (208) is configured to provide audio output to the meeting attendees in the conference room to hear remote meeting attendees and/or to listen to other audio content. One or more speakers may be used. Built-in conference room speaker systems may be used.

The camera (202), the microphone (204), the display (206), and the speaker (208) interface with the local processing service (250) to exchange media data (220), including audio and video data.

The user control interface (210) is configured to enable local meeting attendees to control the endpoint (200). The user control interface (210) may include input and/or output elements such as physical or virtual buttons and/or a display. The display (206) may also be used for the output of the user control interface (210). The user control interface (210) may enable various features, such as one-touch dial to connect to a currently scheduled meeting by a single button press. The scheduled meeting may have previously been communicated to the endpoint (200), e.g., when the meeting was scheduled using, for example, a calendar application or a conference room reservation application. Additionally, the user control interface (210) may provide controls for audio volume, video settings, manually connecting to meetings, etc.

The local processing service (250) includes communication services (252) performing operations to interface the camera (202), the microphone (204), the display (206), and the speaker (208) with other components of the system (100). The other components of the system (100) may include other endpoints, thereby enabling remote conferencing between multiple endpoints via the data input/output (I/O) (290). The operations performed by the communication services (252) may include image/video processing operations including data compression, buffering, noise cancellation, acoustic fencing based on speaker localization, digital image zooming on a current speaker, etc.

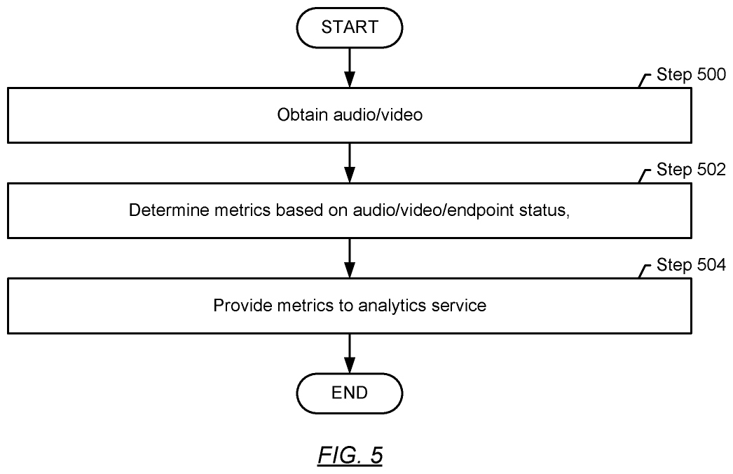

In one or more embodiments, the local processing service (250) further includes a video metrics extraction engine (254) and/or an audio metrics extraction engine (256). The video metrics extraction engine (254) and the audio metrics extraction engine (256) include sets of machine-readable instructions (stored on a computer-readable medium) which when executed enable the endpoint (200) to generate metrics (280) based on the media data (220) obtained from the camera (202) and or the microphone (204), as discussed in detail below with reference to the flowchart of FIG. 5. The metrics (280) are observations extracted from the media data (220), discussed in detail below. The video metrics extraction engine (254) and the audio metrics extraction engine (256) may be configured to extract various different metrics (280) such as, for example, the number of attendees in a meeting, the capacity of the conference room being used, beginning, end, and duration of a meeting, etc. Numerous metrics are discussed below with reference to the flowchart of FIG. 5.

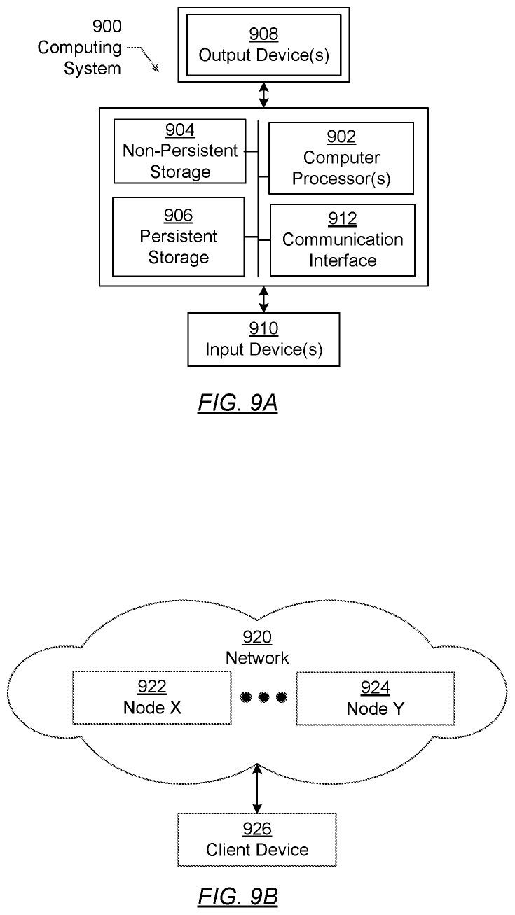

The local processing service (250), including the communication services (252), the video metrics extraction engine (254), and the audio metrics extraction engine (256) may be executed on a computing system of the endpoint (200). The computing system may include at least some of the components of the computing system described in FIGS. 9A and 9B.

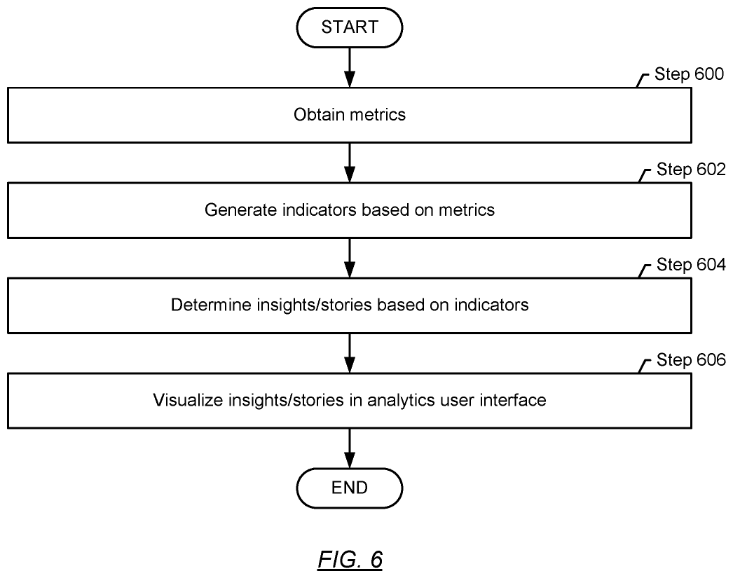

Turning to FIG. 3A, an analytics service (300), in accordance with one or more embodiments of the disclosure, is shown. The analytics service (300) includes a set of machine-readable instructions (stored on a computer-readable medium) which when executed implement various processing modules. The analytics service (300) may be cloud-hosted. A metrics processing module (310) may process the metrics (302) received from one or more endpoints to determine indicators (312). The metrics processing module may receive metrics (302) from many endpoints, e.g., from some or all endpoints located within a building, some or all endpoints used by an organization, some or all endpoints across multiple organizations, etc. An indicator, in one or more embodiments, is a measure intended to provide meaningful information about a particular topic. In one or more embodiments, indicators are numerical measures derived from the metrics. An indicator may be a numeric descriptor of some aspect that may provide a meaningful insight to a person, typically when the numeric descriptor has a value that is considered extreme or unusual. In other words, an insight may be an indicator with some level of statistical divergence. Unlike a metric, an indicator may not be directly measurable. An indicator may be derived from one or more metrics acquired by one or more endpoints. Consider, for example, the topic “meetings that start late”. The percentage of meetings that start more than five minutes after the scheduled start time would be an indicator for this topic. Unlike key performance indicators which may be used to track progress toward achieving a specific desired result, where performance is to be improved based on known aspects that are measured, indicators may be used in scenarios where the aspects to be measured or monitored are not necessarily known. Many indicators may be computed, and through comparison of the indicators with benchmark indicators (e.g., the same indicators obtained from another company, or across companies), the relevant indicators that may serve as useful performance indicators may become apparent. In the example, the indicator may enable an administrator to determine whether the conference room is sub-optimally utilized. Indicators may be organized by topics. For example, the indicator “count of total time occupied” may be under the topic “conference room usage”, whereas the indicator “percentage of time that a conference room is used without prior scheduling” may be under the topic “unscheduled conference room usage”. Additional examples are described in detail below with reference to Step 602 of FIG. 6.

Next, an indicator processing module (320) may process the indicators (312) to determine insights (322) as described in Step 604 of FIG. 6. An insight, in one or more embodiments, is based on an indicator that is determined to be of notability or relevance to a user or administrator. In other words, indicators (312) are potential insights, i.e., insights that are of potential relevance to the user. The indicator may be of potential relevance if the indicator is a potential factor in a decision that the user may make. If the notability of an indicator (312) is sufficiently high, the indicator becomes an insight (322). In such a scenario, the indicator is determined to be of relevance to the user and therefore an insight. The notability or relevance may be based on various criteria or factors. For example, an indicator showing that a conference room is poorly utilized is not necessarily insightful if all other conference rooms within a building are also under-utilized. However, if the utilization of the conference room is at 10%, whereas the average utilization of all conference rooms within the building is at 80%, this may provide an important insight, that should result in a different scheduling of the conference rooms or reconfiguration of the under-utilized conference room to obtain a more balanced utilization. An insight may be tailored to the type of administrator or user receiving an insight feed. For example, an insight suggesting technical problems with the endpoint may be highly relevant to an IT administrator, but it may be less relevant to facilities management. Accordingly, an IT administrator may be provided with the insight, whereas a facilities manager may not be provided with the insight. On the other hand, an under-utilized conference room may be highly relevant to facilities management, and the facilities manager may, thus, be provided with the insight. A detailed description is provided below with reference to the flowcharts.

Turning to FIG. 3B, an example implementation (350) of an analytics service (300), in accordance with one or more embodiments of the disclosure, is shown.

In the example implementation (350), a device messaging service (354) may be responsible for collecting messages from devices (352). The devices (352) may include endpoints as previously described and/or other devices, e.g., environmental sensors (e.g., volatile organic compounds (VOC) sensors, temperature sensors, humidity sensors, light sensors, etc.). The device messaging service (354) may, thus, perform an intake of data from the devices (352) for the cloud environment described below. The messages (which may include metrics provided by the devices (352)) received by the messaging service (354) may be stored in a queue (e.g., in table format) provided by the dirty device data event hub (356). A device data cleaner (358) may process the received messages stored in the dirty device data event hub (356) to address inconsistencies and other issues with the received messages. For example, different devices (352) may provide messages in different formats, e.g., depending on the type of device, the vendor of the device, the model and/or firmware versions. The resulting messages in a homogenous format may be stored by the clean device data event hub (360) which may operate as a queue in a manner similar to the dirty device data event hub (356). The device metrics ingestion module (362) takes the metrics contained in the messages from the clean device data event hub (360) and stores the metrics in the metrics datastore (364). The metric datastore (364) may store a comprehensive history of metrics from all devices (352) over time. All metrics over time or only a limited number of metrics may be stored, e.g., until a certain date in the past. The metrics datastore (364) may be cloud-based and may use a database architecture that is suitable for the intake of a large volume of metrics. In one embodiment, the Parquet™ database file format is used. The metrics curation module (366) operates on the metrics in the metrics datastore (364). The metrics curation module (366) may reorganize the metrics in the metrics datastore (364) in preparation for extracting indicators from the metrics. For example, the metrics curation module (366) may reorganize the metrics from a chronological order to a device-specific order that enables the determination of a device's state at a point in time, based on the metrics associated with the device.

The insight mining module (368) may operate on the curated metrics to generate indicators, which may later become insights, as previously described for the metrics processing module (310) in FIG. 3A. More specifically, the insight mining module (368) may perform one or more of the operations described in Step 602 of FIG. 6. The generated indicators may be annotated with statistics to provide statistical contextual data. Assume, for example, that an indicator is generated for a percentage of meetings starting late for a particular conference room. In this case, the indicator would be a percentage (e.g., 10%), annotated by for example, a mean and a standard deviation across sites, globally, over time, etc. In addition, charts may be generated for the indicators, as further discussed below. The generated indicators, including the contextual statistics, and/or the charts may be stored in an insight datastore (370). The Parquet™ database file format may be used for the insight datastore (370). Referring to FIG. 3A, the described elements (354-370) of the example implementation (350) of the analytics service may be associated with the metrics processing module (310) of the analytics service (300).

The insight exporter module (372) may export the indicators in the insight datastore (370) to the prioritized insights database (374). All or most indicators may be exported. The exporting may result in a different partitioning of the exported indicators. For example, when the insight mining is performed, assume that for an indicator of type x a global (across tenants) mean and standard deviation are calculated. Further assume that a global mean and standard deviation are also calculated for an indicator of type y. Many additional statistics may be calculated for the indicators of type x and type y. To perform the statistics calculations, all indicators of type x may be stored in a single database partition of the insight datastore (370), and all indicators of type y may be stored in a single database partition of the insight datastore (370). The results of the calculations may be written back to new data base partitions of the insight datastore (370). Different database partitions of the insight datastore (370) may be used to store indicators and statistics of types x and y. Indicators associated with different tenants may be stored in the same database partition of the insight datastore (370). After the exporting to the prioritized insights database (374), the indicators may be re-partitioned to be stored in different partitions of the prioritized insights database (374), for different tenants. Indicators of types x and y, including the statistics, may be stored in the same partition of the prioritized insights database (374), for the same tenant. Further, some global statistics (i.e., across different tenants) may also be stored in the same partition of the prioritized insights database (374).

In one embodiment, the prioritized insights database (374) is an SQL database and may allow low-latency retrieval of data using queries to obtain insights from the indicators. The low-latency may be, at least partially, a result of the partitioning of the prioritized insights database (374). Specifically, assume that a query is scoped for one tenant and a particular time period. All indicators that may be targeted by the query may be located in a single partition of the prioritized insights database (374), due to the pre-calculation of the indicators and statistics, followed by the repartitioning during the exporting of the indicators, as previously described. The query may, thus, only require a single sequential read from the same partition of the prioritized insights database (374). A just-in-time retrieval of any number of indicators to provide insights is, thus, feasible. A scoring, discussed below in reference to Step 604 of the flowchart of FIG. 6, may be used in conjunction with a query when accessing the prioritized insights database (374) to obtain an insight to be presented to a user. Referring to FIG. 3A, the described elements (372, 374) of the example implementation (350) of the analytics service may be associated with the indicator processing module (320) of the analytics service (300). The query used to access the prioritized insights database (374) may be customized by applying user-specific weights to identify the indicators that are of particular relevance to the user associated with the query.

The story telling module (376) may be involved in determining the weights to be used for scoring the indicators in a user-specific manner. Initially, the interests of a user may not be known. In such a case, indicators may be uniformly scored. As the user is interacting with the indicators considered insights, the story telling module (376) may identify the relevance of the indicators to the user and may adjust the weights accordingly. Over time, the story telling module (376) is, thus, able to selectively pick indicators that are of relevance to the user, while ignoring other indicators. The information that is learned about the user, over time, may be stored in the feedback datastore (378). For example, weights for individual user and/or weights for classes of users may be stored in the feedback datastore (378). The information that is learned about the user may be obtained by the story telling module (376) and/or other modules. The information may include, for example: (i) direct user feedback based on ratings/thumbs up etc. from insights seen by the users; (ii) configuration parameters of a user or tenants particular interests; (iii) data collected from what insights/stories a user looks at, and how long they spend looking at them; (iv) data collected from website usage tracking tools such as Google Analytics; and (v) indications of which insights a user has seen or not yet seen.

Insights and/or stories may be provided to a user interface (382) via an API gateway (380). The API gateway (380) may ensure proper user authentication and the user interface (382) may enable the user to receive and interact with the insights and/or stories.

The example implementation (350) of the analytics further includes a management API (384). The management API (384) may be responsible for the intake of information that may result in indicators that do not directly originate from the devices (352). For example, an indicator may be generated for a scheduled downtime of one or more device (352), or for other system management events. Any other type of external data may be accepted by the management API (384). Events obtained by the management API (384) may be stored in a queue (e.g., in table format) provided by the insight event hub (386). The insight ingestion module (388) may generate indicators from the events, comparable to the operations performed by the device metrics ingestion module (362), the metrics curation module (366), and the insight mining module (368). The obtained indicators may be stored in the insight datastore (370). Information related to users and/or user groups may be stored in the feedback datastore (378).

The example implementation (350) of the analytics further includes a one-touch-dial (OTD) service (390). The OTD service may be used to configure the devices (352) with meeting information, including a meeting schedule, meeting participants, etc. The OTD metrics ingestion module (392) takes the meeting information and stores the meeting information in the metrics datastore (364).

Turning to FIG. 4, an example analytics user interface in accordance with one or more embodiments, is schematically shown. The analytics user interface (400) includes a landing page (410). A description of the landing page is provided below with reference to FIG. 7A, based on an example. From the landing page, one may navigate to various sections, including sections for device inventory (420), device health (430), device usage (440), conference room usage (450) and other possible sections. Each of these sections may include various views such as map views (422, 432, 442, 452), chart views (424, 434, 444, 454), table views (426, 436, 446, 456), and device detail views (428, 438, 448, 458). A map view, a table view, and a device detail view are described below in FIGS. 7B, 7C, and 7D, respectively, based on examples.

FIGS. 5 and 6 show flowcharts in accordance with one or more embodiments of the disclosure. While the various steps in these flowcharts are provided and described sequentially, one of ordinary skill will appreciate that some or all of the steps may be executed in different orders, may be combined or omitted, and some or all of the steps may be executed in parallel. Furthermore, the steps may be performed actively or passively. For example, some steps may be performed using polling or be interrupt driven in accordance with one or more embodiments of the disclosure. By way of an example, determination steps may not require a processor to process an instruction unless an interrupt is received to signify that condition exists in accordance with one or more embodiments of the disclosure. As another example, determination steps may be performed by performing a test, such as checking a data value to test whether the value is consistent with the tested condition in accordance with one or more embodiments of the disclosure.

Turning to FIG. 5, a flowchart describing a method for a processing performed by an endpoint, in accordance with one or more embodiments, is shown. The steps described in FIG. 5 may be performed in addition to other operations. For example, the endpoint may communicate with other endpoints to establish a live audio and/or video link. The steps described in FIG. 5 may be repeatedly performed, e.g., at a fixed rate.

In Step 500, audio and/or video data are obtained. Audio data may be continuously obtained via the microphone of the endpoint. All audio data or selected one or more samples may be considered for further processing in the following steps. Video data may be continuously obtained via the camera of the endpoint. All or a portion of image frames (e.g., periodically grabbed image frames) may be considered for further processing in the following steps. Additional data such as the status of the endpoint itself, including error flags, the current configuration, installed software versions, scheduled meetings, call details, etc., may be obtained.

In Step 502, metrics are determined based on the data obtained in Step 500.

Metrics, in accordance with one or more embodiments, are quantifications of observable phenomena detected in the audio and/or video data. The obtaining of metrics locally on the endpoint may have the advantage that raw video/audio data are not transmitted to the analytics service, thereby reducing bandwidth requirements and privacy concerns. In addition, the resulting data reduction reduces the challenge of storing data in cloud space.

Examples of metrics include but are not limited to:
A count of people in the conference room (based on the number of people detected in the conference room (e.g., from a software analysis of video frames captured using the camera))
A capacity of the conference room (based on the number of chairs detected by a computing system in the room) or more generally, a room layout, including physical dimensions of the room, positions of tables, chairs, monitors, whiteboards, microphones, room lighting, etc.
A meeting schedule for the conference room (based on the meeting requests that were scheduled for the endpoint, such as by using a conference reservation system)
Actual call details, including a beginning time of the meeting, and end time of the meeting (as detected by the endpoint)
Call quality, measured during a call. A mean opinion score (MOS), jitter, latency, and/or packet loss may be used to assess call quality on the endpoint.

In one or more embodiments, one or more of the metrics are generated using methods of machine learning. More specifically, the video data may be processed by an image classifier machine learning algorithm to perform object identification and/or localization. Convolutional neural networks (CNNs) may be used to perform the object identification/localization based on image frames obtained from the camera of the endpoint. Identified objects may include, but are not limited to, chairs, tables, humans (faces), equipment such as laptops, monitors, whiteboards, conference room doors, etc. The machine learning algorithm may be pre-trained or may be trained using data collected by the endpoint. To conduct the training using endpoint video data, the endpoint may be operated in a sampling mode. In the sampling mode, image data from the camera may be collected and sent to a computing system where the training of the machine learning algorithm is performed. By comparing the output of the machine learning algorithm on a training input with correct value for the training input, a loss function is evaluated and used to update the weights of the machine learning algorithm. Thus, the machine learning algorithm is trained by iteratively adjusting the weights. Multiple such machine learning algorithms may exist. Namely, different metrics may have individual one or more machine learning algorithms that are used to determine the value of the metrics based on audio/video streams and other inputs. Once training is completed, the machine learning algorithm may be downloaded to the endpoint.

The audio data may be processed by a set of machine learning algorithms to decode, for example, an anonymized speaker identity (speaker 1, speaker 2, etc.), speech start and end times, speaker sentiment, profanity count, language, etc. Other metrics, including word clouds, transcripts, etc., may be obtained. Due to the potential sensitivity (e.g., confidentiality) of these metrics, generation of these metrics may require explicit activation or approval by the users of the conference room and/or by an administrator. Further, an appropriate notification may be provided in the conference room to make users aware of the feature being active. Additional processing may be performed to further reduce the transmission of potentially sensitive information by the endpoint. For example, a word cloud may be reduced to a meeting topic to be sent as a metric. To perform the audio processing in a speaker-specific manner, speakers may be distinguished using audio-based speaker localization and/or a visual detection of the speaker. At least some of the machine-learning algorithms for processing the audio data may be pre-trained. Further, the machine learning algorithms may be trained using sampled audio data, analogous to the previously described training of the machine learning algorithms for the video data.

Additional metrics may be available based on the status of the endpoint. For example, error flags, inputs provided by meeting attendees when operating the user control interface, metrics associated with ongoing or completed calls, etc. may be included in the metrics.

Other metrics may also be available from analyzing a meeting request used for setting up the meeting. The meeting request may specify the type of meeting, scheduled beginning and end of the meeting, the names of the participants, the purpose of the meeting, etc.

In Step 504, the metrics may be provided to the analytics service. The metrics may be transmitted at regular time intervals, when updated metrics become available, and/or upon request by the analytics service.

Turning to FIG. 6, a flowchart describing a method for a processing performed by an analytics service, in accordance with one or more embodiments, is shown. The steps described in FIG. 6 may be repeatedly performed, e.g., at a fixed rate, or whenever new metrics are obtained from an endpoint. While FIG. 6 describes steps performed based on metrics received from a single endpoint, these steps may be performed for multiple endpoints, e.g., all endpoints configured to operate with the analytics service.

In Step 600, metrics are obtained. The obtained metrics may be stored in a database (e.g., SQL-type database) or other data repository. Metrics may be obtained from one or more endpoints and/or from elsewhere. For example, metrics may also be obtained from a scheduling system, e.g., in the form of calendaring data from calendar applications, conference room reservation applications, and/or any other sources of metrics.

In Step 602, indicators are determined based on the metrics. In one or more embodiments, indicators are numerical measures derived from the metrics, that are intended to provide meaningful information about a particular topic. Consider, for example, the topic “meetings that start late”. The percentage of meetings that start more than five minutes after the scheduled start time would be an indicator for this topic.

Many indicators may be calculated in Step 602. More specifically, there may be an indicator for each topic, and the indicator may be calculated for different scopes (e.g., in location and/or time). For example, an indicator may be calculated for each conference room or endpoint, for each site of an organization, across the entire organization, and/or across multiple organizations. Similarly, an indicator may be calculated for right now, for each of the most recent calendar days, for each of the most recent calendar weeks, for each of the most recent calendar months, for each of the most recent quarters, for each of the most recent years, etc. Indicators may also be calculated for each of different endpoint types or models, and/or for each software version of the endpoints. Indicators may further distinguish between types of meeting attendees. Types of attendees may include, but are not limited to: organization-internal vs organization-external attendees, executives vs non-executive employees, employees with particular qualifications, clearances, titles, etc. The type of attendee may be determined, for example, based on information from a conference room reservation system, e.g., based on who was contacted with a meeting invite. Different indicators and/or insights may be generated, based on the types of attendees in a meeting room. Additionally, the types of attendees found in a meeting room may be used to generate one or more additional insights such as, for example: “Conference room is used 80% by executives”.

The following are examples for indicators that may be calculated. Each example is introduced by a topic indicator, followed by the indicator itself, which may be a numeric measure of the topic.
Conference room usage—Count of total time occupied, or call minutes and average time occupied or average call minutes per room per day, per week, or per month, etc. The indicator may be obtained based on metrics such as endpoint usage or activity or persons detected in the conference room.
Unscheduled conference room usage—Percentage of time that a conference room is used without prior scheduling. The indicator may be obtained based on metrics such as endpoint usage or activity or persons detected in the conference room, and the meeting schedule for the conference room.
Meetings that start late—Percentage of scheduled meetings that were not in a call shortly after the scheduled start time, e.g., five minutes after the scheduled start time, but that were eventually in a call during the scheduled time. The indicator may be obtained based on metrics such as endpoint activity and the meeting schedule for the conference room.
Meetings that run long—Percentage of scheduled meetings that were still in call after the scheduled end time, e.g., one minute after the scheduled end time. The indicator may be obtained based on metrics such as endpoint usage or activity and the meeting schedule for the conference room.
Conference rooms scheduled but not used—Percentage of scheduled meetings for which the conference room was empty. The indicator may be obtained based on metrics such as endpoint usage or activity and the meeting schedule for the conference room. A count of people present in the conference room may also be used.
Average meeting size—Average number of people in the room for all times that there was someone in the room. The indicator may be obtained based on metrics such as counts of people present in the conference room.
Recurring meetings with no participants—Percentage of recurring meetings with no participants. The indicator may be obtained based on metrics such as the meeting schedule for the conference room and counts of people present in the conference room.
Offline endpoints—Percentage of endpoints that are offline. The indicator may be obtained based on metrics such as endpoint status (or missing endpoint status updates).
Endpoints used—Percentage of endpoints that had at least one call in, for example, the last week. The indicator may be obtained based on metrics such as endpoint activity.
Endpoints unused—Percentage of endpoints for which no calls existed during a defined time, e.g., during the last week, despite the endpoints being connected and available. The indicator may be obtained based on metrics such as endpoint activity and/or endpoint status.
Endpoints out of service—Percentage of endpoints that were offline for a specified time interval, e.g., the last week. The indicator may be obtained based on metrics such as endpoint status (or missing endpoint status updates).
Call usage—In-call minutes per endpoints per day. The indicator may be obtained based on metrics such as endpoint activity.
Endpoint software—Percentage of endpoints that have software updates available. The indicator may be obtained based on metrics such as endpoint status.
Repeated call restarts—Multiple call restarts may be a sign of connectivity issues. The indicator may be obtained based on metrics such as endpoint activity.

Broadly speaking, the above indicators may reflect device usage, device health, call quality, and conference room usage.

In one or more embodiments, determining the indicators further involves pre-computing charts for at least some of the indicators. Pre-computing a chart for an indicator may involve identifying the chart type to be used to display the indicator (e.g., a line chart, a bar graph, a pie graph, etc.), a chart time period (e.g. a year, a month, a day, an hour, etc.), and a chart increment (e.g., a month, a day, an hour, a minute, etc.). Assume, for example, that the time period is one year. In this case, a meaningful chart increment may be one month. The chart type, the chart time period, and the chart increment may be pre-set for each indicator, such that when the chart is pre-computed for the indicator, the necessary data for the chart may be gathered.

In addition, related indicators may be obtained for visualization in the chart. For example, if the indicator for which the chart is generated is for a particular endpoint, data for all endpoints within the building, or across the organization may be obtained, to allow comparison and facilitate interpretation of the chart, by the user. Charts may, thus, provide additional context to a user reviewing indicators. Similarly, a cross-linking between indicators may be stored, e.g., based on parent-child relationships. For example, an endpoint in a conference room may have a parent that is the combination of all endpoints in a building. Multiple parents may be defined. For example, another parent for the endpoint (which is a particular model of endpoint) may be a family of endpoints that accommodates different models of endpoints, etc.

In Step 604, insights are determined based on the indicators. In one or more embodiments, insights are intended to help an administrator or user identify which indicators are interesting.

The following are examples of insights, organized by category of the insight, topic of the insight, the indicator used for the insight, the time scope of the insight, the location scope of the insight, and possible data sources for the insight
Category: Room Utilization; Topic: Room Usage; Indicator: Count and Average Count of occupied or in-call minutes, Average per room per day; Time Scopes: Day (D)/Week (W)/ Month (M)/ Quarter (Q)/ Year (Y); Location Scopes: Tenant Site, Room; Data Source: PeopleCount CDR, AppState PDI (CDR: Call Detail Record (message sent from endpoint to cloud service documenting a single teleconference call), PDI: Primary Device Information (message sent from endpoint to cloud service, describing basic properties of endpoint))
Category: Room Utilization; Topic: Unscheduled room usage; Indicator: Count and Total Count of occupied or in-call minutes where no call was scheduled, Total of occupied or in-call minutes; Time Scopes: D/W/M/Q/Y; Location Scopes: Tenant, Site, Room; Data Source: PeopleCount CDR, OTD (OTD: One Touch Deployment (data obtained from a deployment service. Includes info about when conference room containing the endpoint was scheduled, whether the scheduled time was a recurring meeting)
Category: Room Utilization; Topic: Meetings that start late; Indicator: Count and Total Count of scheduled meetings that were not in call five minutes after the scheduled start time, Total of scheduled meetings in time period; Time Scopes: D/W/M/Q/Y; Location Scopes: Tenant, Site, Room; Data Source: OTD, CDR, PDI
Category: Room Utilization; Topic: Meetings that run long; Indicator: Count and Total, Count of scheduled meetings that were still in call one minute after the scheduled end time, Total of scheduled meetings in time period; Time Scopes: D/W/M/Q/Y; Location Scopes: Tenant, Site, Room; Data Source: OTD, CDR, PDI
Category: Room Utilization; Topic: Rooms scheduled but not used; Indicator: Count and Total, Count of scheduled meetings for which the room was empty, Total of scheduled meetings in time period; Time Scopes: D/W/M/Q/Y; Location Scopes: Tenant, Site, Room; Data Source: OTD, CDR, PDI
Category: Average People Per Room; Topic: Average meeting size; Indicator: Average, the average number of people in the room, when the room was not empty. De-bounced to compensate for spurious changes in people count; Time Scopes: D/W/M/Q/Y; Location Scopes: Tenant, Site, Room; Data Source: PeopleCount CDR
Category: Average People Per Room; Topic: Recurring meetings with no participants; Indicator: Count and Total Count of recurring meetings for which the room was empty. Total of recurring meetings in time period; Time Scopes: D/W/M/Q/Y; Location Scopes: Tenant, Site, Room; Data Source: People Count CDR, OTD
Category: Device Health; Topic: Offline Devices; Indicator: Count and Total per Day, i.e., Count of devices that are offline at any point in day. Total number of devices registered at any point in the day. For longer time periods, Count is the average Count of all days in the time period. Total is the average Total of all days in the time period; Time Scopes: D/W/M/Q/Y; Location Scopes: Tenant, Site, Device Type, Family, Model, Version, Model Version, Device; Data Source: RECONNECT, DISCONNECT (Data gathered by cloud service about when connectivity between endpoint and cloud service started/ended), PDI
Category: Endpoint Adoption; Topic: Devices used; Indicator: Count and Total, e.g., per week: Count of devices with at least one call during the week. Total number of devices registered at any point in the week. For longer time periods, Count is the average Count of all weeks in the time period. Total is the average Total of all weeks in the time period; Time Scopes: W/M/Q/Y; Location Scopes: Tenant, Site, Device Type, Family, Model, Version, Model Version, Device; Data Source: CDR, AppState (Message sent from endpoint to cloud service, reporting whether in call or not. Substitute for CDR message when not enough information to generate CDR message), PDI
Category: Endpoint Adoption; Topic: Devices unused; Indicator: Count and Total, e.g., per week: Count of devices online at some point during the week, but with no calls during the week. Total number of devices registered at any point in the week. For longer time periods, Count is the average Count of all weeks in the time period. Total is the average Total of all weeks in the time period; Time Scopes: W/M/Q/Y; Location Scopes: Tenant, Site, Device Type, Family, Model, Version, Model Version, Device; Data Source: CDR, AppState, PDI
Category: Endpoint Adoption; Topic: Devices out of service; Indicator: Count and Total, e.g., per week: Count of devices offline for the entire week. Total number of devices registered at any point in the week. Longer time periods: Count is the average Count of all weeks in the time period. Total is the average Total of all weeks in the time period; Time Scopes: W/M/Q/Y; Location Scopes: Tenant, Site, Device Type, Family, Model, Version, Model Version, Device; Data Source: RECONNECT, DISCONNECT, PDI
Category: Endpoint Adoption; Topic: Call usage; Indicator: Count and Average, Count of in-call minutes. Average is per device per day; Time Scopes: D/W/M/Q/Y; Location Scopes: Tenant, Site, Device Type, Family, Model, Version, Model Version, Device; Data Source: CDR, AppState, PDI
Category: Management; Topic: Device Software; Indicator: Count and Total, e.g., per Day: Count of devices with a software update available at the end of the day. Total number of devices registered at any point in the day. For longer time periods: Count is the average Count of all days in the time period. Total is the average Total of all days in the time period; Time Scopes: D/W/M/Q/Y; Location Scopes: Tenant, Site, Device Type, Family, Model, Version, Model Version, Device; Data Source: PDI

A notability score may be used as a measure of how interesting a particular insight is expected to be. An insight that is more interesting to a user has a higher relevance to that user. Consider, for example, a conference room utilization of 90%. This indicator alone is not necessarily informative. However, if the observed conference room utilization is 80% higher than the average conference room utilization this may be notable and may suggest that meetings should be distributed differently across the available conference rooms. In this case, a higher notability score may result in the indicator being converted to an insight. Generally speaking, indicators associated with a higher notability score may be presented to the user or administrator as insights, whereas indicators associated with lower notability scores may not be presented to the user or administrator. Indicators may be ranked, based on their associated notability scores. Higher-ranking indicators may be selected over lower-ranking indicators to become insights. A threshold may be used to select high-ranking indicators as insights. For example, the top 10-ranked indicators may become insights, or the top 10% indicators, based on the ranking, may become insights.

Identifying more relevant insights may be beneficial when large numbers of indicators are available. Merely presenting a collection of indicators to the administrator or user may be overwhelming, while important information may potentially not get conveyed to the administrator or user. Assume, for example, that there are 13 topics based on indicators (such as “meetings that start late”, etc.), each of which may be computed for different scopes such as a time scope (each day of the most recent week, each week of the most recent month, each month of the most recent year, and the most recent year, for example), a location scope (global, tenant, tenant site, room, device type, family, model, version, model version, device, etc.), and possibly other scopes. Different scopes may help identify different problems, when it is not clear, a priori, which indicators might be insightful. For example, offline devices caused by a power outage may show up best in an indicator scoped by day, whereas offline devices caused by an intermittent network failure may show up best in an indicator scoped by month. In the example with the 13 topics, each topic has an episode for each of 29 time periods (7 days, 5 weeks, 12 months, 4 quarters, 1 year) for each endpoint, site and tenant. A tenant with 100 endpoints at 10 sites would, thus, have a total of 377,000 episodes, each of which may or may not be of interest to the user or administrator. The example illustrates that the volume of information resulting from these indicators may be difficult to impossible to asses for a human. Further, not all administrators are interested in the same insights. For example, an administrator in IT may be interested in which devices fail most often, while the head of facilities may be interested in which conference rooms are consistently overbooked. To determine insights that are relevant to an administrator, the insights and/or indicators that the administrator historically interacts with may be tracked. This may include identifying the insights that are accessed, the time spent on reviewing the insights, the level of detail that is accessed (e.g., by selecting related insights, e.g., parent or child insights), etc. A profile of what the administrator is interested in may thus be established. Classifier-type machine learning algorithms may be used to determine the administrator's interests. Similarly, classifier-type machine learning algorithms and/or clustering algorithms may also be used to determine the interests of classes of users. Users with similar interests may form clusters. Users in a particular cluster may be provided with the same or similar insights. Alternatively, a static profile, initially established for the administrator, may be used. A notability score is thus used, as described below, to identify only the more or most relevant indicators for presentation to a user or administrator. Accordingly, an insight may be created based on an episode of an indicator if a notability score associated with the episode exceeds a prespecified threshold. For example, when a problem is local to a particular site, site-scoped indicators for that site may have the most notability markers, resulting in the highest notability scores, thus causing these indicators to be displayed. Alternatively, when there is a problem specific to a particular software version, version scoped indicators for that version may have the most notability markers, etc.

In one or more embodiments, an episode (i.e. an occurrence) of an indicator is assigned a numeric notability score to quantify the notability, thus indicating how interesting the episode is expected to be. Episodes are then sorted by notability, and only the most notable episodes are presented to users.

The notability score may be generated from a combination of sub-scores. Of the sub-scores, a base score may serve as a measure of how good or bad the indicator is. A trend score may serve as a measure of how fast the indicator value is changing. A rollup independence score may serve as a measure of whether the insight is more notable than the rollup-insights that contain it, to avoid multiple reportings of the same insight. For example, the rollup independence score may be used to suppress redundant reportings for devices using different scopes such as a room-based scope and a site-based scope. In one or more embodiments, the sub-scores of the notability scores are derived from notability markers. Each indicator may be marked with multiple notability markers, describing whether the indicator has certain features.

Conceptually, the notability score may consist of a base score that is then discounted based on the trend and rollup independence scores. Accordingly, an indicator may never be more notable than indicated by the episode's base score. However, the indicator may be scored as less notable because it is not changing, or the phenomenon is better illustrated by a different indicator.

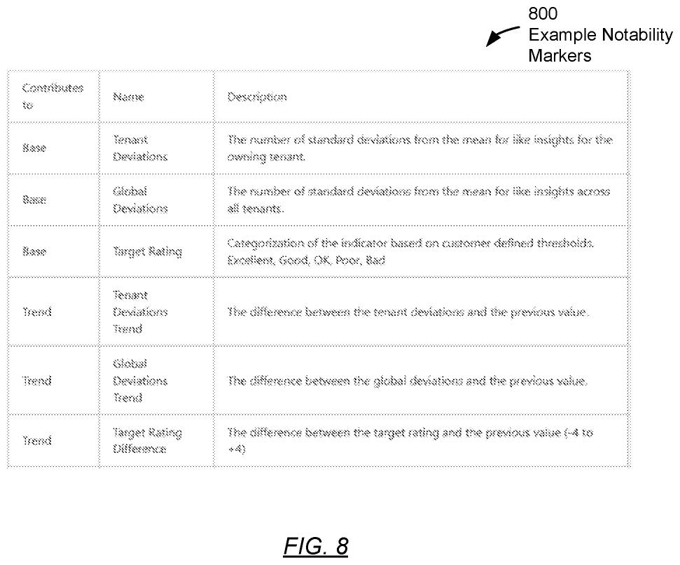

The sub-scores of the notability score may be derived from notability markers. Each episode may be marked with a notability marker, depending on whether the episode has certain features. Various notability markers are introduced in FIG. 8. Each notability marker may have a weight, which is a numerical coefficient that specifies how much the notability marker contributes to the sub-score that it belongs to. Each sub-score also may have a weight, which is a numerical coefficient that specifies how much the notability score may be discounted by that sub-score. The weights may be static, or they may be adaptively determined.

The notability score may be calculated as follows:

Notability score=Base score*Weighted Trend sub-score*Weighted Rollup independence sub-score

### Where:

weighted sub-score=(1−weight)+(weight*raw sub-score),

where the calculation of the weighted sub-score may be used for each of the weighted trend sub-score and the weighted rollup independence sub-score.

Each of the sub-scores may be computed using the formula score=Σₙ₌₁ⁿwⁿmⁿ, where mⁿ is the value of the n-th notability marker, and where wⁿ is the weight of the n-th notability marker. The weights and the notability markers may be chosen to be in a range between 0.0 and 1.0.

The following are examples for notability markers that may be used:
Tenant Deviations—The number of standard deviations from the mean for like insights for the owning tenant.
Global Deviations—The number of standard deviations from the mean for like insights across all tenants.
Tenant Deviations Trend—The difference between the tenant deviations and the previous value.
Global Deviations Trend—The difference between the global deviations and the previous value.
Broadly speaking, a notability marker may, thus, quantify statistical deviations of the underlying indicator.

Referring to the calculation of sub-scores, the base score may be calculated as:

Capped|Tenant Deviations|*Tenant Deviations Weight+Capped|Global Deviations|*Global Deviations Weight,

where the Tenant and Global Deviations are capped at a value of four standard deviations from the mean. Accordingly, for the purpose of score calculation, events that are more than four standard deviations from the mean will be treated as four standard deviations from the mean. The base score may thus establish how good or bad the indicator is, based on how statistically unusual the indicator is. Some topics are considered as not insightful if the topics document only small populations of insights. For example, if a single device of a particular model and version exists, and that device is offline, the preferred insight to display is that that device is offline, rather than that 100% of devices with that model and version are offline. To accomplish this, each (Topic, Location Scope) may have a minimum population size. Insights derived from fewer endpoints than the minimum population size are scored as zero.

Still referring to the calculation of sub-scores, the trend score may be calculated as:

Capped|Tenant Deviations Trend|*Tenant Deviations Weight+Capped|Global Deviations Trend|*Global Deviations Weight.

The Tenant Deviations Trend and Global Deviations Trend are capped, for example, at 4.0.

Still referring to the calculation of sub-scores, a rollup independence score may also be calculated. The rollup independence score may be used to prevent redundant reportings of the same insight. Various insights might get rolled up. For example, an insight on a site level may get rolled up to tenant level, an insight on a room level may get rolled up to site level, an insight on a device type level may get rolled up to tenant level, and insight on a device family level may get rolled up to device type level, an insight on a model level may get rolled up to family level, an insight on a version level may get rolled up to family level, an insight on a model version level may get rolled up to model and/or version level, an insight on a device level may get rolled up to a model version and/or site level. Consider, for example, a scenario in which an endpoint is offline all week. As a result, the base notability score for the “endpoint is offline” indicator is high for multiple time scopes: Monday, Tuesday, Wednesday, the whole week, the whole month, etc. It may be preferable to generate a single insight for this event, not one for every affected time scope. Similarly, an event may affect multiple location scopes, and only one insight should be generated. For example, if a site only has one room, for every site insight there may be a corresponding room insight containing the same set of devices. The rollup independence score is a mechanism that may be used to suppress duplicate insights. In the system, scopes “roll up”: Days roll up into weeks. Weeks roll up into months. Endpoints roll up into rooms. Rooms roll up into sites. There may be many more scope rollups. For each scope rollup, a hierarchy may be established. The timing hierarchy may be: current, day, month, quarter, year. The location hierarchy may be: device, organization, site, tenant. The model hierarchy may be: device, model/software version, version, family, type. The version hierarchy may be: device, model/software version, version, family, type. Accordingly, when calculating a rollup independence score, each indicator may be a member of multiple rollup hierarchies and thus may have multiple different parents. When calculating the rollup independence score, the most notable parent is used. The rollup independence score is a numerical indicator that an indicator that is notable at a particular scope is also notable at a second scope that the first scope rolls up into. As such, the rollup independence score reduces the notability score of the indicator. Assigning high scores to both an insight and the insight that it rolls up into is, thus, avoided by de-weighting insights that are redundant with the insight they roll up into. Broadly speaking, the rollup independence score may thus prevent redundant reportings of indicators using different scopes. Two additional notability markers may be used to implement the rollup independence score: Rollup Tenant Deviations and Rollup Global Deviations. Rollup Tenant Deviations is the tenant deviations value of the insight which the insight rolls up to. If the insight rolls up into two other insights, it is the one with the greater absolute value. Rollup Global Deviations is the global deviations value of the insight which the insight rolls up to. If the insight rolls up into two other insights, it is the one with the greater absolute value.

The rollup independence score is calculated as:

When tenant deviations are positive:

Tenant part=Min(Max(Tenant Deviations−Rollup Tenant Deviations, 0.0), 0.5)

When tenant deviations are negative:

Tenant part=Min(Max(−1*(Tenant Deviations−Rollup Tenant Deviations), 0.0), 0.5)

When global deviations are positive:

Global part=Min(Max(Global Deviations−Rollup Global Deviations, 0.0), 0.5)

When global deviations are negative:

Global part=Min(Max(−1*(Global Deviations−Rollup Global Deviations), 0.0), 0.5)

Rollup independence score=2* Max(Tenant part, Global part)

The result may be a rollup independence score ranging between zero when the insight is less deviant than the rollup and 1 when the insight is 0.5 or more deviations greater than the rollup. Consequently, any insight that is equally or less deviant than the insight it rolls up into will be maximally de-weighted, with the de-weighting phased out as the insight becomes more deviant than the rollup, and completely phased out if the insight is half a deviation more deviant than the rollup.

As previously noted, weights may be tuned to specific contexts by analyzing user feedback. Initially a baseline set of weights may be used. The baseline set of weights may be chosen such that at least somewhat meaningful insights are presented to users. The baseline weights may be established in the form or rules chosen to manifest a set of heuristics about whether an indicator is notable:
Comparisons within a tenant and comparisons between tenants should contribute about equally when determining notability
“Bad news” is more notable than “Good news”. An indicator delivering the best possible news should have about 80% of the score of an insight delivering the worst possible news
Trends within a tenant and trends against all tenants should contribute about equally when determining notability
An indicator is slightly less notable when it has the same value as it had during the previous period. This should discount the score by about 20%
Indicators for degenerate categories are not notable. A degenerate category is one where there is one or less endpoint in that category.
Indicators are notable to a tenant if they relate to that specific tenant. Indicators of global patterns/trends are not notable
Indicators that compare a tenant to the average of all tenants are equally notable to indicators that compare different parts of a tenant to each other
Indicators relating to a single device are less notable than indicators relating to groups of devices. This should discount the score by about 20%
It is not very notable that devices are online. Indicators indicating that fewer devices are offline than average should be discounted by about 60%
“Good news” about a single endpoint is not notable at all
The “devices used” indicator is never notable when applied to a single endpoint
Family scoped insights are not currently notable, because the families for all supported devices is the same as the model
Indicators that are not independent of their rollup are much less notable. This should discount the score by about 80%
Rollup independence is not a meaningful concept for indicators that compare the tenant average to the global average

The following example is intended to illustrate how heuristics may be used to derive the baseline weights:
Base score:
The base score is calculated using the formula: base score=tenant deviations*tenant deviations weight+global deviations*global deviations weight, where:
tenant deviations is a notability marker measuring how different the indicator is from similar indicators for the same tenant with a range of possible values from −4.0 to 4.0
global deviations is a notability marker measuring of how different the indicator is from similar indicators across all tenants with a range of possible values from −4.0 to 4.0
the expected value of base score is between 0.0 and 1.0, and so weights that generated unexpected values must not be used
the following heuristics apply:
   comparisons with a tenant and comparisons between tenants should contribute about equally when determining notability
   “bad news” is more notable than “good news”. An indicator delivering the best possible news should have about 80% of the score of an insight delivering the worst possible news.

The chosen baseline weights are:
tenant deviations: −0.125 if tenant deviations is negative, and 0.1 otherwise
global deviations: −0.125 if global deviations is negative, and 0.1 otherwise.

In an example of applying these weights, an indicator represents really good news about room usage at a particular site. The room usage is more than four standard deviations higher than the average of all sites at the tenant, and more than four standard deviations higher than the average of all sites globally. Accordingly:

Base score=tenant deviations*tenant deviations weight+global deviations*global deviations weight=4*0.1+4*0.1=0.8.

Subsequently, a story telling may be performed. The story telling may be based on an analysis of one or more insights in view of benchmark insights, e.g., insights obtained from other tenants. A comparison of the one or more insights with the benchmark insights may result in a recommendation geared toward driving the indicators underlying the one or more insight toward values that would get the one or more insights to harmonize with the benchmark insights.

In one example, a story is generated in the form of a site facilities analysis. The site facilities analysis may include various insights that may enable or facilitate facilities planning, e.g., by a building manager. Examples of insights that are included in the site facilities analysis are:
Types of meetings taking place at the site, including, for example, the duration of the meetings, a graph of meeting counts for different durations and/or a graph of total meeting minutes for different durations.
Size of meetings taking place at the site, including, for example, a graph of meeting counts for different numbers of people in the meeting and/or a graph of meeting minutes for different numbers of people in the meeting
Time of meetings taking place at the site, including, for example, a graph of meeting counts for different times of day and/or a graph of meeting minutes for different times of day
Mode of meetings taking place at the site, including, for example, a graph of meeting counts for audio, video, and in person meetings, and/or a graph of meeting minutes for audio, video, and in person meetings
Ecosystems used for meetings (e.g., Microsoft Teams, Zoom, Poly Real Presence Platform, Cisco, etc.), including, for example, a graph of meeting counts by ecosystem and/or a graph of meeting minutes by ecosystem
Match between facilities and actual needs, including, for example, a quantification of how frequently occupied the rooms of the facility are, e.g., based on a chair count; a quantification of how hard is it to find a room, e.g., based on a chair count; a quantification of how often the rooms crowded; a quantification of how often big rooms are used for small meetings; a determination whether the appropriate endpoints are used, based on meetings sizes; a quantification of how often all the rooms are in use; a composite availability score reflecting whether people can find the room they need when they need it; and/or a composite utilization score reflecting whether the facilities at the site are actually being used.

In Step 608, insights and/or stories, tailored to the administrator viewing the insights and/or stories are visualized in an analytics user interface. Insights may be supplemented by additional content. For example, explanatory articles (such as best practices for keeping meetings from running long), and insightful charts may be included.

An analytics user interface enabling the administrator to view and interact with insights and/or indicators is described below.

One or more of Steps 600-608 may involve coordination between time zones.

When creating insights, it may be necessary or desirable to take into account the peculiarities resulting from both endpoints and users being distributed all over the world. As a result, insights may be in different time zones from each other, and from the users examining them. For device level insights (e.g., for an endpoint), it may be desirable to have the time period of the insights match the time zones of the devices themselves. For example, consider two devices, one in Westminster (GMT−7) and one in New Delhi (GMT+5:30). Assume that each of the two devices has an insight for the day Monday, Feb. 10, 2020. For the Westminster device, this time period extends from local midnight on the tenth to Local midnight on the eleventh (GMT: Monday February 10th 7am to Tuesday February 11th 7am). For the New Delhi device, this time period also extends from local midnight on the tenth to Local midnight on the eleventh, but the GMT time is different: (GMT: Sunday February 9th 6:30pm to Monday February 10th 6:30pm). For roll up insights, it may be beneficial to adjust for the time difference to capture the relevant device metrics using local time. In the example, assume that a roll up insight capturing total call minutes is determined for the two endpoints. An aggregation is performed in the local time periods for each of the two devices. Accordingly, the total call minutes for Monday, February 10 include the total call minutes for the Westminster device for local February 10 (GMT: Monday February 10th 7am to Tuesday February 11th 7am) plus the total call minutes for the New Delhi device for local February 10 (GMT: Sunday February 9th 6:30pm to Monday February 10th 6:30pm).

Time zones may further affect when an insight may be published. A first strategy may involve publication of an insight may be delayed until the time period is complete (e.g., until the insight can be determined based on metrics of all devices in their local time zones. A second strategy may involve publication of an insight at any time, e.g., when the time period begins, followed by updates of the insight as time goes on, until the time period ends. The second strategy may be beneficial for longer time periods. For example, it may be useful to have a year-to-date insight rather than waiting for the end of the year. The choice of the strategy may be configurable for each combination of a topic and a time scope.

Insights that are configured to be published upon completion of the time period may be published to the user when the time period has ended for every device included in the insight scope. In the above example, the insight for Monday, February 10 for New Delhi is published at Monday February 10th 6:30pm GMT, while the insight for Monday, February 10 for Westminster is published at Tuesday February 11th 7am GMT.

It may be possible for a new device to be added to an insight scope after the corresponding insight has been published. In this case, the existing insight may be retracted and republished at the new end of the period. For example, assume that a new endpoint is installed in Honolulu (GMT-10) on February 10 at 10pm. This is Tuesday February 11th 8am GMT, after the insight containing only Westminster and New Delhi endpoints has already been published. This existing insight for February 10 is removed. The insight may reappear at Tuesday February 11th 10am GMT (when the day ends in Honolulu) containing the combined New Delhi, Westminster, and Honolulu data. Insights that are published when the time period begins, then updated as time goes on may be published as soon as the time period begins for the first device in the insight scope.

When an insight has been published for a certain amount of time, it may be sunsetted. Sunsetted insights may no longer be shown on the priority insights screen. The time between publication and sunsetting is configurable for each combination of topic and time scope. In the example, if (call usage, day) insights are configured to be sunsetted after two days, the New Delhi insight, which was published at Monday February 10th 6:30pm GMT is sunsetted at Wednesday February 12th at 6:30pm GMT.

FIGS. 7A, 7B, 7C, and 7D show examples of analytics user interfaces, in accordance with one or more embodiments of the disclosure.

Turning to FIG. 7A, an example landing page (700) is shown. In the example landing page, the administrator is presented with a feed of insights ordered by their notability. In the example, the insight indicating that a firmware update is available is most prominently featured. The relative importance (notability) of an insight may be reflected by a scaling of the insight, in the landing page. Additionally or alternatively, insights may be ordered, color-coded, etc. While not shown in the example landing page (700), the underlying markers of notability may also be shown to allow the administrator to assess why a particular indicator is worth looking at.

For a facilities manager, the landing page (700) (and/or other pages of the analytics user interface) may focus on workspace occupancy and workspace utilization such as whether conference rooms are generally used or not used, the capacity of the conference room(s) used (occupancy), whiteboards or other resources being used, whether meetings are scheduled but do not occur, whether meetings are scheduled but begin late, whether meetings are scheduled and extend beyond the scheduled end time, etc. This information may inform the facilities manager's decision regarding whether rooms need to be scheduled differently, whether additional rooms are needed, whether there are issues with a room that is rarely or never used, etc. For example, the facilities manager may eventually determine that the unused conference room has defective equipment, is remote, is uncomfortable, provides insufficient privacy, that potential users do not know about the existence of the room, etc. In contrast, for an IT manager, the landing page (700) may focus on technology-related information. For example, the emphasis may be on defective endpoints, endpoints that are offline, missing hardware (such as stolen video cables), outdated firmware, etc.

The administrator may be able to browse the presented indicators. For each indicator, contextual data to facilitate the interpretation of the presented data may be provided. This includes trends, previous values, organization average, percentile within the organization, average of multiple organizations, percentile over multiple organizations, etc. Further, contextually appropriate links to tools for corrective action, actionable recommendations, and views of additional data may be provided.

The administrator may further be able to share the presented indicators. For example, a facilities manager may want to share the finding that the current conference rooms are insufficient with the CEO to support a request for additional conference rooms.

Turning to FIG. 7B, an example map view (710) is shown. The map view provides a count of devices (including video endpoints, audio endpoints (phones), and headsets), and a global distribution of the devices. The map view may be available at various zoom levels, and additional details (e.g., device details) may be explored.

Turning to FIG. 7C, an example device health table view (720) is shown. The device table view provides, for a list of devices, various device details. Additional details may be obtained for each device when switching to the device' s device detail view.

Turning to FIG. 7D, an example device detail view (730) is shown. The device detail view may enable an administrator to examine, manage, and configure the device.

Turning to FIG. 8, example notability markers (800), in accordance with one or more embodiments, are shown in a table. The table includes a column indicating the score to which a notability marker contributes, a name, and a description of the not notability marker.

Embodiments of the disclosure may be implemented on a computing system.

Any combination of mobile, desktop, server, router, switch, embedded device, or other types of hardware may be used. For example, as shown in FIG. 9A, the computing system (900) may include one or more computer processors (902), non-persistent storage (904) (e.g., volatile memory, such as random access memory (RAM), cache memory), persistent storage (906) (e.g., a hard disk, an optical drive such as a compact disk (CD) drive or digital versatile disk (DVD) drive, a flash memory, etc.), a communication interface (912) (e.g., Bluetooth interface, infrared interface, network interface, optical interface, etc.), and numerous other elements and functionalities.

The computer processor(s) (902) may be an integrated circuit for processing instructions. For example, the computer processor(s) may be one or more cores or micro-cores of a processor. The computing system (900) may also include one or more input devices (910), such as a touchscreen, keyboard, mouse, microphone, touchpad, electronic pen, or any other type of input device.

The communication interface (912) may include an integrated circuit for connecting the computing system (900) to a network (not shown) (e.g., a local area network (LAN), a wide area network (WAN) such as the Internet, mobile network, or any other type of network) and/or to another device, such as another computing device.

Further, the computing system (900) may include one or more output devices (908), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (902), non-persistent storage (904), and persistent storage (906). Many different types of computing systems exist, and the aforementioned input and output device(s) may take other forms.

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosure.

The computing system (900) in FIG. 9A may be connected to or be a part of a network. For example, as shown in FIG. 9B, the network (920) may include multiple nodes (e.g., node X (922), node Y (924)). Each node may correspond to a computing system, such as the computing system shown in FIG. 9A, or a group of nodes combined may correspond to the computing system shown in FIG. 9A.

By way of an example, embodiments of the disclosure may be implemented on a node of a distributed system that is connected to other nodes. By way of another example, embodiments of the disclosure may be implemented on a distributed computing system having multiple nodes, where each portion of the disclosure may be located on a different node within the distributed computing system. Further, one or more elements of the aforementioned computing system (900) may be located at a remote location and connected to the other elements over a network.

Although not shown in FIG. 9B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (922), node Y (924)) in the network (920) may be configured to provide services for a client device (926). For example, the nodes may be part of a cloud computing system. The nodes may include functionality to receive requests from the client device (926) and transmit responses to the client device (926). The client device (926) may be a computing system, such as the computing system shown in FIG. 9A. Further, the client device (926) may include and/or perform all or a portion of one or more embodiments of the disclosure.

The computing system or group of computing systems described in FIGS. 9A and 9B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the disclosure. The processes may be part of the same or different application and may execute on the same or different computing system.

Rather than or in addition to sharing data between processes, the computing system performing one or more embodiments of the disclosure may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the disclosure, may extract one or more data items from the obtained data. For example, the extraction may be performed as follows by the computing system in FIG. 9A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query provided to a structured data repository (where the data repository may be organized according to a database schema or data format, such as XML).

The extracted data may be used for further processing by the computing system. For example, the computing system of FIG. 9A, while performing one or more embodiments of the disclosure, may perform data comparison. Data comparison may be used to compare two or more data values (e.g., A, B). For example, one or more embodiments may determine whether A>B, A=B, A!=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the disclosure, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 9A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the

DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 9A may include functionality to provide raw and/or processed data, such as results of comparisons and other processing. For example, providing data may be accomplished through various presenting methods. Specifically, data may be provided through a user interface provided by a computing device. The user interface may include a GUI that displays information on a display device, such as a computer monitor or a touchscreen on a handheld computer device. The GUI may include various GUI widgets that organize what data is shown as well as how data is provided to a user. Furthermore, the GUI may provide data directly to the user, e.g., data provided as actual data values through text, or rendered by the computing device into a visual representation of the data, such as through visualizing a data model.

For example, a GUI may first obtain a notification from a software application requesting that a particular data object be provided within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be provided through various audio methods. In particular, data may be rendered into an audio format and provided as sound through one or more speakers operably connected to a computing device.

Data may also be provided to a user through haptic methods. For example, haptic methods may include vibrations or other physical signals generated by the computing system. For example, data may be provided to a user using a vibration generated by a handheld computer device with a predefined duration and intensity of the vibration to communicate the data.

The above description of functions presents only a few examples of functions performed by the computing system of FIG. 9A and the nodes and/ or client device in FIG. 9B. Other functions may be performed using one or more embodiments of the disclosure.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An analytics and device management platform comprising:
a computer processor; and
instructions executing on the computer processor causing the analytics and device management platform to:
obtain metrics from at least one endpoint,
wherein each of the metrics is a quantification of a phenomenon detected in at least one of audio and video data obtained from an endpoint configured to facilitate communication between meeting attendees;
generate indicators based on the metrics,
wherein each of the indicators is a numeric descriptor derived from at least one of the metrics, and
wherein each of the indicators is of potential relevance to a user of the analytics and device management platform to inform a decision by the user;
determine at least one insight based on the indicators,
wherein the at least one insight is an indicator determined to be of relevance to the user to inform the decision; and
provide the at least one insight to a user interface for visualization.

2. The analytics and device management platform of claim 1, wherein the instructions further cause the analytics and device management platform to obtain metrics from a scheduling system.

3. The analytics and device management platform of claim 1, wherein generating the indicators comprises:
determining a plurality of indicators for at least one of the metrics, wherein each of the plurality of indicators is for a different scope.

4. The analytics and device management platform of claim 3, where the different scope is at least one selected from the group consisting of a different scope in time and a different scope in location.

5. The analytics and device management platform of claim 1, wherein the metrics are directed to at least one selected from the group consisting of an endpoint usage, an endpoint health, a call quality of a call conducted using the endpoint, and a conference room usage of a conference room where the endpoint is located.

6. The analytics and device management platform of claim 1, wherein determining the at least one insight based on the indicators comprises:
for each particular indicator of the indicators, determining a corresponding notability score, as a measure of relevance of the particular indicator to the user;
ranking the indicators based on the corresponding notability score to obtain a ranking; and
selecting indicators to become the insights based on the ranking.

7. The analytics and device management platform of claim 6, wherein the notability score is computed from sub-scores, the sub-scores comprising:
a base score quantifying a quality of the particular indicator based on a statistical divergence of the particular indicator, and
discounting sub-scores for discounting the base score.

8. The analytics and device management platform of claim 7, wherein the discounting sub-scores comprises a rollup independence score configured to prevent redundant reportings of the particular indicator and another indicator that uses a different scope.

9. The analytics and device management platform of claim 7, wherein the sub-scores comprises a sub-score based on notability markers and weights applied to the notability markers,
wherein the notability markers quantify statistical deviations of the particular indicator.

10. The analytics and device management platform of claim 9, wherein the weights are set based on a plurality of rules chosen to manifest a set of heuristics.

11. The analytics and device management platform of claim 1, further comprising generating a site facilities analysis for a site of an organization, the site facilities analysis comprising a set of insights selected from the at least one insight,
wherein the set of insights is directed to meetings taking place at the site.

12. A method for operating an analytics and device management platform, the method comprising:
obtaining metrics from at least one endpoint,
wherein each of the metrics is a quantification of a phenomenon detected in at least one of audio and video data obtained from an endpoint configured to facilitate communication between meeting attendees;
generating indicators based on the metrics,
wherein each of the indicators is a numeric descriptor derived from at least one of the metrics, and
wherein each of the indicators is of potential relevance to a user of the analytics and device management platform to inform a decision by the user;
determining at least one insight based on the indicators,
wherein the at least one insight is an indicator determined to be of relevance to the user to inform the decision; and
providing the at least one insight to a user interface for visualization.

13. The method of claim 12, further comprising obtaining metrics from a scheduling system.

14. The method of claim 12, wherein generating the indicators comprises:
determining a plurality of indicators for at least one of the metrics, wherein each of the plurality of indicators is for a different scope.

15. The method of claim 12, wherein determining the at least one insight based on the indicators comprises:
for each particular indicator of the indicators, determining a corresponding notability score, as a measure of relevance of the particular indicator to the user;
ranking the indicators based on the corresponding notability score to obtain a ranking; and
selecting indicators to become the insights based on the ranking.

16. The method of claim 15, wherein the notability score is computed from sub-scores, the sub-scores comprising:
a base score quantifying a quality of the particular indicator based on a statistical divergence of the particular indicator, and
discounting sub-scores for discounting the base score.

17. The method of claim 16, wherein one of the sub-scores is based on notability markers and weights applied to the notability markers,
wherein the notability markers quantify statistical deviations of the particular indicator.

18. The method of claim 12, further comprising generating a site facilities analysis for a site of an organization, the site facilities analysis comprising a set of insights selected from the at least one insight,
wherein the set of insights is directed to meetings taking place at the site.

19. A non-transitory computer readable medium comprising computer readable program code causing an analytics and device management platform to perform operations comprising:
obtaining metrics from at least one endpoint,
wherein each of the metrics is a quantification of a phenomenon detected in at least one of audio and video data obtained from an endpoint configured to facilitate communication between meeting attendees;
generating indicators based on the metrics,
wherein each of the indicators is a numeric descriptor derived from at least one of the metrics, and
wherein each of the indicators is of potential relevance to a user of the analytics and device management platform to inform a decision by the user;
determining at least one insight based on the indicators,
wherein the at least one insight is an indicator determined to be of relevance to the user to inform the decision; and
providing the at least one insight to a user interface for visualization.

20. The non-transitory computer readable medium of claim 19, wherein determining the at least one insight based on the indicators comprises:
for each particular indicator of the indicators, determining a corresponding notability score, as a measure of relevance of the particular indicator to the user;
ranking the indicators based on the corresponding notability score to obtain a ranking; and
selecting indicators to become the insights based on the ranking.
